(19) United States
(12) Patent Application Publication
(10) Pub. No.: US 2009/0323343 A1
(43) Pub. Date: Dec. 31, 2009

(54) LAMP BASE IMPROVEMENT OF A STREET LAMP

(76) Inventor: Pei-Choa WANG, Gueishan Township (TW)

Correspondence Address: HDLS Patent & Trademark Services, P.O. BOX 220746, CHANTILLY, VA, 20153-0746, US

(21) Appl. No.: 12/164,321

(22) Filed: Jun. 30, 2008

(51) Int. Cl. F21V 21/00; F21V 29/02

(52) U.S. Cl. 362/249.11; 362/373

(57) ABSTRACT

An illumination device of a lamp base improvement of a street lamp to change the projection direction is disclosed. A lamp base formed a plurality of brackets inside. Bottoms of the brackets are longitudinally set to be slanted. Lighting modules corresponding to the brackets are disposed along the bottoms. A transparent mask is combined to the lamp base to cover those lighting modules. Whereby, it can provide an LED street lamp which can change the projection direction.

### BACKGROUND OF THE INVENTION

1. Field of the Invention

The present invention relates to a light emitting diode (LED) lamp, and more particularly to a lamp base structure of an LED street lamp.

2. Description of the Prior Art

For a conventional mercury street lamp of illumination, the high heat resulting from long use always makes its service life limited. Because of its high power consuming and environmental pollution, it tends to be replaced by a light emitting diode (LED) illumination device for advantages of high intensity, power saving and long service life, etc.

Street lamps are used to guide passengers and indicate vehicles. There has been a determined distance between two street lamps to avoid setting too many street lamps for saving costs. However, there often are unlit areas between street lamps on roads. In a worst-case, the safety of passengers is at risk.

A major reason why the unlit areas exist is the included angle between a lamp base and a lamp pole of a street lamp. As shown in FIG. 1A, is a schematic view for current street lighting. It includes a lamp pole 1, a lamp arm 2 and a lamp set 3. The included angle between the lamp arm 2 and the lamp pole 1 is an unvarying quantity of X, it is usually about 101 degree to 105 degree. Under this included angle, a projected area on the ground of the lamp set 3 is A. Please refer to FIG. 1B, the included angle between the lamp arm 2 and the lamp pole 1 is changed to Y. Because the direction of the lamp set 3 projecting to the ground is changed, the projected area on the ground by the lamp set 3 is enlarged from A to B. Accordingly, it can solve the problem of unlit areas between street lamps.

From above mentioned, to change the direction of the lamp set 3 projecting to the ground is to change the included angle between the lamp arm 2 and the lamp pole 1. However, the included angle between the lamp arm 2 and the lamp pole 1 is always fixed. In order to change the included angle between the lamp arm 2 and the lamp pole 1, a new lamp pole 1 and the lamp arm 2 with a different included angle there between must be rebuilt to replace the original one. This will cost a lot of money, labor and time. Especially street lamps are public property, to replace numerous lamp poles 1 tends to be considered as wasting public treasury. Therefore, how to change the direction of the lamp set 3 projecting to the ground under the original lamp pole 1 and the lamp arm 2 is an important problem to be solved.

### SUMMARY OF THE INVENTION

Accordingly, one object of the present invention is to provide a lamp base improvement of a street lamp, which can solve the problem of unlit areas between street lamps by setting a longitudinally slanted bottom of a bracket of a lamp base. The invention can change the direction of the lamp set projecting to the ground without rebuilding lamp poles and lamp arms.

In order to achieve the object mentioned above, the present invention provides a lamp base improvement of a street lamp. It mainly includes a lamp base, which forms a plurality of brackets inside. The brackets are set to have longitudinally slanted bottoms with respect to a transparent mask. Inside the lamp base, lighting modules are separately disposed on a bottom of the brackets. The transparent mask is assembled to the lamp base to cover the plurality of lighting modules. Hereby, it provides a illumination device which can change the projection direction to solve the problem of unlit areas between street lamps. Also, it can save lots of costs of replacing lamp poles of street lamps.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The above and further advantages of this invention may be better understood by referring to the following description, taken in conjunction with the accompanying drawings, in which:

FIG. 1A is a schematic view showing a included angle X of a lamp arm and a lamp pole of conventional street lamps;

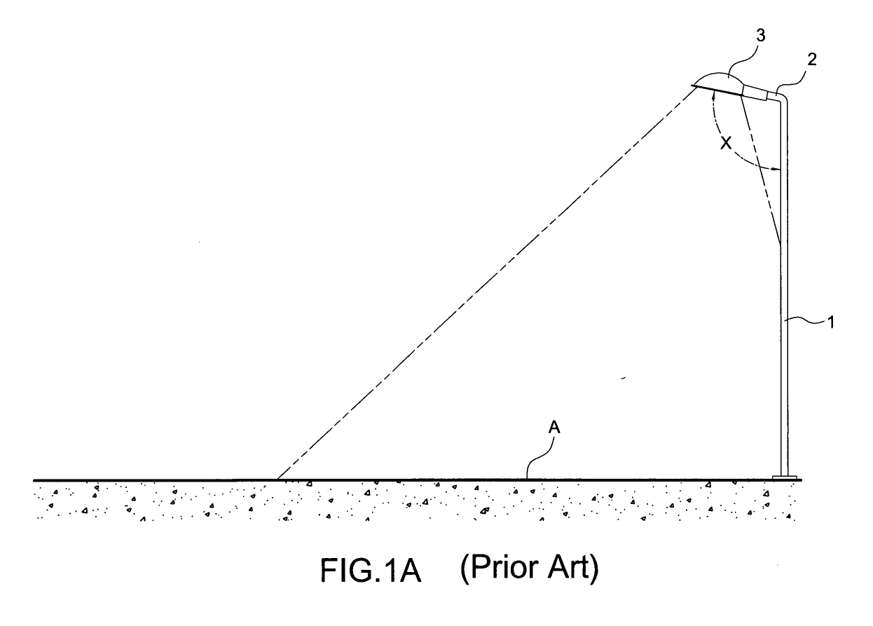

FIG. 1B is a schematic view showing a included angle Y of a lamp arm and a lamp pole of conventional street lamps;

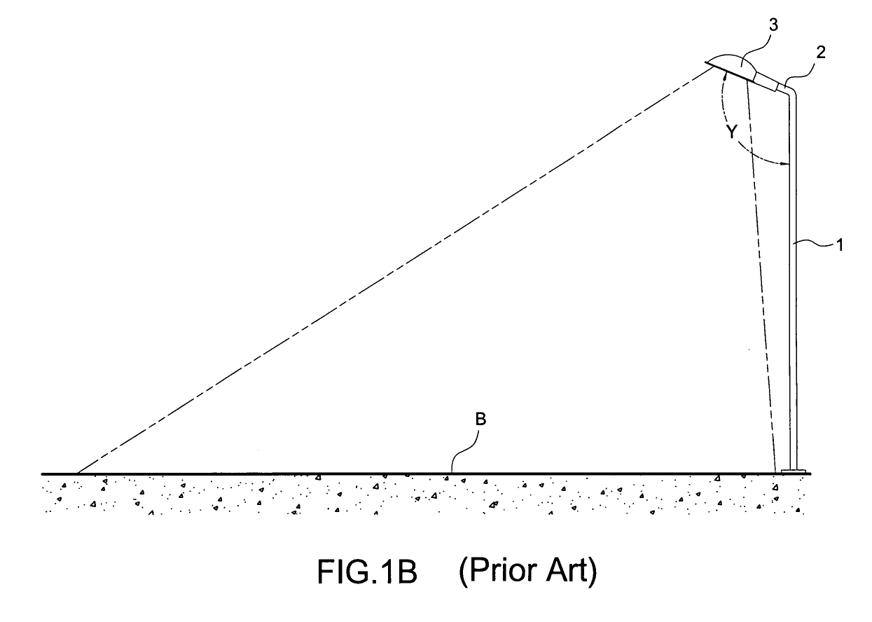

FIG. 2 is an exploded view of the present invention;

FIG. 3 is an assembled view of the present invention;

FIG. 4 is a sectional view of the present invention;

FIG. 5 is an another sectional view of the present invention; and

FIG. 6 is a schematic view showing the present invention applied to a street lamp.

The drawings will be described further in connection with the following detailed description of the present invention.

### DETAILED DESCRIPTION OF THE PREFERRED EMBODIMENTS

Reference will now be made to the drawing figures to describe the present invention in detail.

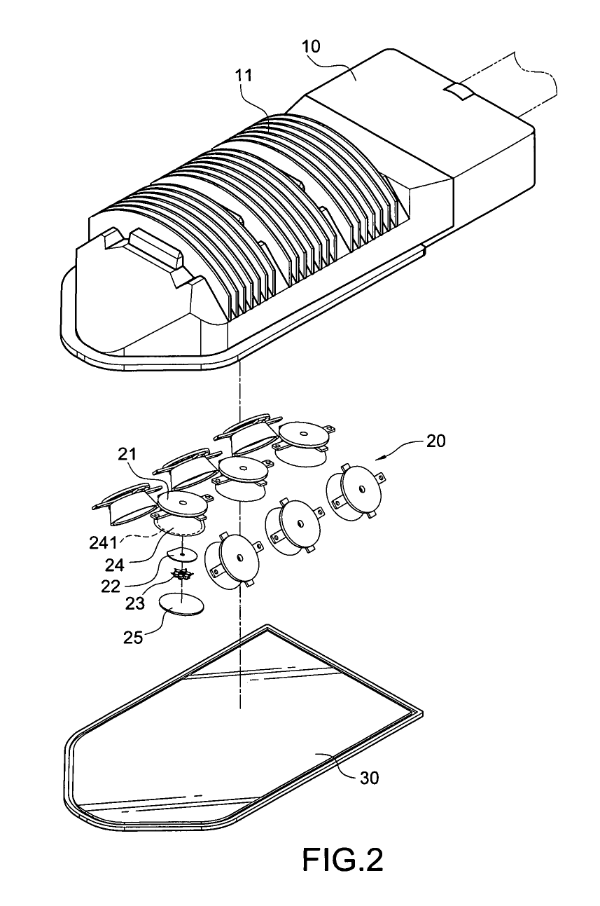

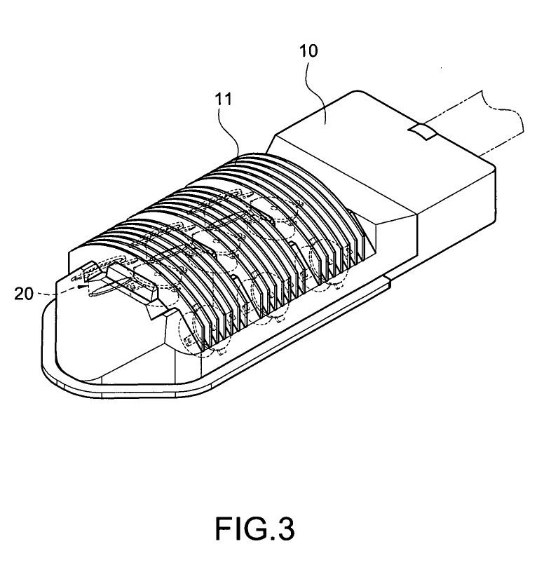

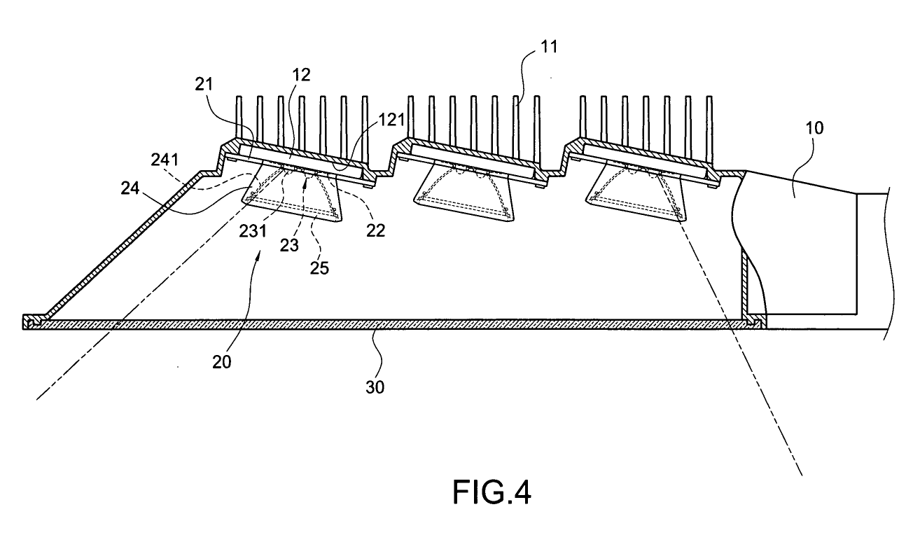

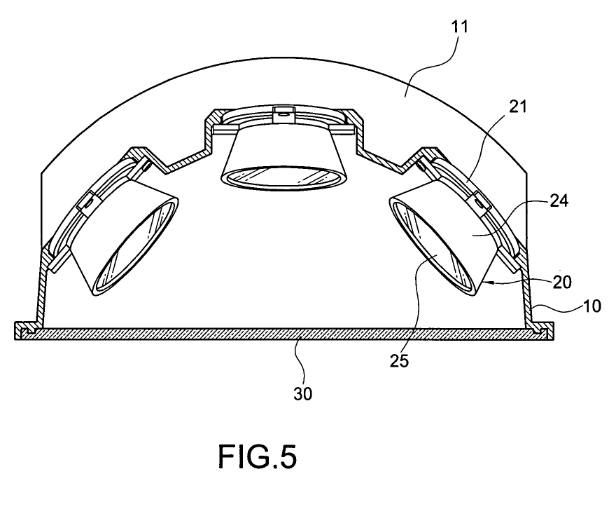

Please refer from FIGS. 2-5. The present invention is to provide a lamp base improvement of a street lamp. It includes a lamp base 10, a plurality of lighting modules 20 and a transparent mask 30. The lamp base 10 is made of die casting aluminum. A plurality of heat dissipating fins 11 and brackets 12 are disposed on the outside and inside of the lamp base 10, respectively. The brackets 12 are array arranged and bowl shaped, or a cross section of the bracket 12 is trapezoid shaped. The brackets 12 are arranged into a ladder-shape in a longitudinal direction and having at least three longitudinal lines (refer to FIG. 3 and FIG. 5). Two outside lines of brackets 12 are slanted inward for light gathering. One preferred embodiment, there is nine brackets 12 in the lamp base 10, and each bracket 12 disposing a lighting module 20. In real practice, the number of brackets 12 and its corresponding lighting modules 20 can be adjusted by demanded.

The lighting module 20 includes a fixing base 21, a substrate 22, a lighting unit 23, a refection cover 24 and a lens 25. The fixing base 21 is fixed on the bottom 121 of the bracket 12, and the substrate 22 is disposed on the fixing base 21. The lighting unit 23 including a plurality of LEDs is connected to the substrate 22. The refection cover 24 which has an accommodating space 241 therein for receiving the lighting unit 23. One end of the refection cover 24 is fixed on the fixing base 21, and the other end is covered with the lens 25. The lens 25 can be a Fresnel Lens for enhancing light convergence of the lighting module 20. The corresponsive arrangement between the lens 25 and the refection cover 24 can allow adjusting the angle projecting to the ground for enlarging the effective lit area. Because the fixing base 21 is disposed on the bottom of the bracket 12, the lighting modules 20 connecting to the fixing base 21 are also disposed along the bottom of the bracket 12 inside the lamp base 10. Even more, the transparent mask 30 being a flat plate is disposed on the lamp base 10 to cover sealedly those lighting modules 20. The transparent mask 30 can make illumination components sealed in the lamp base 10 to prevent from humidity and ultimately being damaged. Besides, the bottom 121 of the bracket 12 inside the lamp base 10 is longitudinally slanted with respect to the transparent mask 30.

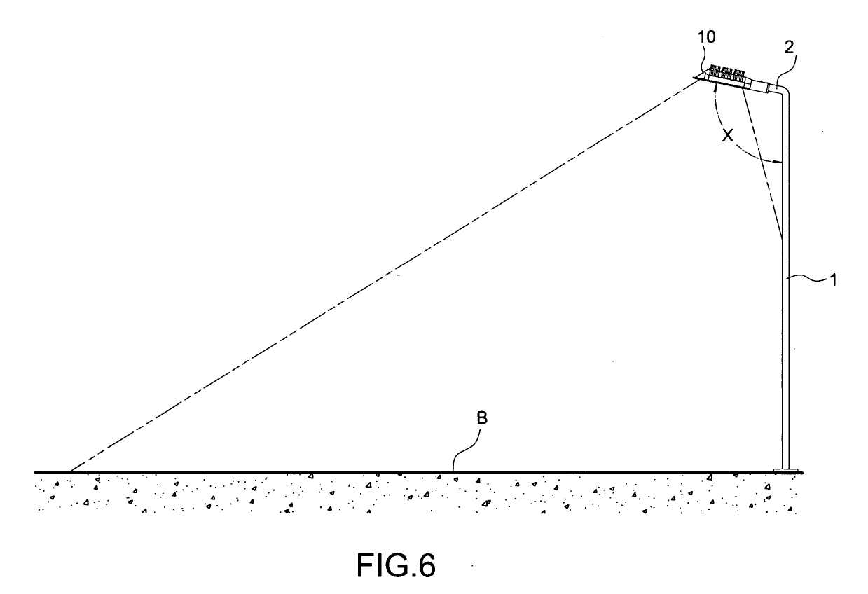

As showed in FIG. 6, is a schematic view showing a lamp base improvement of the present invention improvement, which is applied to a street lamp. The invention lamp base 10 is assembled on the lamp arm 2 of a lamp pole 1. The included angle between the lamp arm 2 and the lamp pole 1 of a street lamp is X. With the invention of lamp base 10, the projecting area from the lamp base 10 on the lamp arm 2 towards the ground is B. Compared with a conventional lamp base, the lamp base 10 of the invention can change projecting direction for adjusting projecting area of the street lamps.

Therefore, the lamp base 10 improvement of a street lamp is on the bracket 12, which is longitudinally to set the bottom 121 to be slanted. By setting a plurality of lighting modules 20 on the bottom 121 of the bracket 12, it can provide an LED street lamp which can change the projecting direction. Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A lamp base of a street lamp, comprising:
a plurality of brackets;
a plurality of lighting modules separately disposed on a bottom of the brackets; and
a transparent mask being a flat plate disposed in the lamp base for sealedly covering the lighting modules;
wherein, the bottom of the bracket with respect to the transparent mask is longitudinally set to be slanted.

2. The lamp base of a street lamp in claim 1, wherein the lamp base is made of die casting aluminum.

3. The lamp base of a street lamp in claim 1, wherein an outside of the lamp base is formed with a plurality of heat dissipating fins.

4. The lamp base of a street lamp in claim 1, wherein the bracket is bowl shaped.

5. The lamp base of a street lamp in claim 1, wherein a cross section of the bracket is trapezoid shaped.

6. The lamp base of a street lamp in claim 1, wherein the brackets are arranged into at least three longitudinal lines, and two outside lines of brackets are slanted inward.

7. The lamp base of a street lamp in claim 1, wherein the brackets are arranged into a ladder-shape in a longitudinal direction.

8. The lamp base of a street lamp in claim 1, wherein the lighting module comprising:
a fixing base being fixed on the bottom of the bracket;
a substrate being disposed on the fixing base;
a lighting unit including a plurality of light emitting diodes and connected to the substrate;
a refection cover having an accommodating space therein for receiving the lighting unit, and one end of the reflection cover being fixed on the substrate; and
a lens covering an another end of the reflection cover.

9. The lamp base of a street lamp in claim 8, wherein the lens is a Fresnel Lens.
